(19) United States
(12) Patent Application Publication
(10) Pub. No.: US 2026/0083616 A1
(43) Pub. Date: Mar. 26, 2026

(54) ROLLATOR WITH ADJUSTABLE HANDLEBARS

(71) Applicant: Ching-Tsang WU, New Taipei City (TW)

(72) Inventor: Ching-Tsang WU, New Taipei City (TW)

(21) Appl. No.: 19/328,906

(22) Filed: Sep. 15, 2025

(30) Foreign Application Priority Data
Sep. 23, 2024 (TW) 113135939

(51) Int. Cl. A61H 3/04

(52) U.S. Cl. CPC A61H 3/04; A61H 2201/0161; A61H 2201/0192; A61H 2201/1418; A61H 2201/1635; A61H 2201/1676

(57) ABSTRACT

A rollator includes a frame unit and two handlebar units. The frame unit includes a main body, and two adjustable bar devices. Each adjustable bar device includes an extendable bar assembly and an adjustment unit. The extendable bar assembly includes an outer tube that has an open groove, and an inner tube that is extendable and retractable relative to the outer tube, and that has multiple recess portions. The adjustment unit includes a secure seat, a push rod, a push block, at least one resilient member and an operation member. The secure seat has an opening, and a recess space spatially communicating with the opening and overlapping the open groove. A length of the push rod in a second direction is greater than a width of the push rod in a third direction. The push rod is pressed to engage one of the recess portions.

### CROSS-REFERENCE TO RELATED APPLICATION

This application claims priority to Taiwanese Invention Patent Application No. 113135939, filed on Sep. 23, 2024, the entire disclosure of which is incorporated by reference herein.

### FIELD

The disclosure relates to an adjustable bar system such as a telescope bar system, and more particularly to a rollator with adjustable handlebars.

### BACKGROUND

A telescope bar can be used in applications that require adjustment of height or length, such as, but not limited to, transport chairs, rollators, wheelchairs, walkers, rehabilitation equipment, exercise equipment, etc.

A conventional telescope bar assembly includes an outer tube, an inner tube, and a latch member. The outer tube has a plurality of positioning holes spaced apart from each other in a top-bottom direction. The latch member is mounted between the inner tube and the outer tube, and has a resilient ball that extends through and engages one of the positioning holes. By pressing the resilient ball inward, the outer tube can be moved in the top-bottom direction relative to the inner tube, thereby adjusting the length of the conventional telescope bar system. When the conventional telescope bar assembly is adjusted to the desired length, the resilient ball is released to engage another one of the positioning holes, thereby positioning the outer tube relative to the inner tube, which achieves the effect of adjusting the length of the conventional telescope bar assembly.

However, the aforementioned conventional telescope bar assembly is positioned only by the single-point engagement of the resilient ball, and the engagement area is small. Thus, the outer tube is prone to wobbling relative to the inner tube, resulting in poor stability. There is still room for improvement.

### SUMMARY

Therefore, an object of the disclosure is to provide a rollator with adjustable handlebars that can alleviate at least one of the drawbacks of the prior art.

According to the disclosure, the rollator with adjustable handlebars includes a frame unit and two handlebar units. The frame unit includes a main body which is movable, and two adjustable bar devices which are respectively disposed on two opposite sides of the main body. Each of the adjustable bar devices includes an extendable bar assembly and an adjustment unit. The extendable bar assembly includes an outer tube and an inner tube that is extendable and retractable relative to the outer tube in a first direction. The outer tube has an open groove. The inner tube has a plurality of recess portions that are spaced apart from each other in the first direction. The adjustment unit is mounted to the extendable bar assembly for adjusting extension and retraction of the extendable bar assembly, and includes a secure seat, a push rod, a push block, at least one resilient member and an operation member. The secure seat has an opening through which the outer tube extends so that the secure seat is sleeved on an end of the outer tube, and a recess space which spatially communicates with the opening and which overlaps the open groove of the outer tube. The push rod extends in a second direction transverse to the first direction, and is accommodated in the recess space of the secure seat and the open groove of the outer tube. A length of the push rod in the second direction is greater than a width of the push rod in a third direction transverse to the first direction and the second direction. The push rod is pressed to engage one of the plurality of recess portions of the inner tube. The push block is movable in the third direction, and is disposed on the secure seat. The at least one resilient member is resiliently pressed, is disposed between the push rod and the push block, and is able to resiliently bias the push rod to move toward the inner tube for engaging one of the plurality of recess portions of the inner tube. The operation member is movably disposed on the secure seat, and is operable for urging the push block to move in the third direction. The handlebar units are respectively disposed on the adjustable bar devices, and each includes a handlebar member that is mounted to the extendable bar assembly of the respective adjustable bar device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an embodiment of a rollator with adjustable handlebars according to the disclosure.

FIG. 2A and FIG. 2B are schematic views illustrating an adjustable bar device of the embodiment being at different positions.

FIG. 3 is a fragmentary partly exploded perspective view of the adjustable bar device.

FIG. 4 is a fragmentary sectional view taken along line IV-IV in FIG. 1.

FIG. 5 is a fragmentary perspective view of the adjustable bar device.

FIG. 6 is a fragmentary exploded perspective view of the adjustable bar device.

FIG. 7 is another fragmentary exploded perspective view of the adjustable bar device.

FIG. 8 is a fragmentary sectional view taken alone line VIII-VIII in FIG. 2A, where an operation member of the adjustable bar device is in a limitation position.

FIG. 9 is a fragmentary perspective sectional view of an adjustment unit of the embodiment.

FIG. 10 is a fragmentary top view of the adjustable bar device.

FIG. 11 is another fragmentary sectional view, where the operation member is in a release position.

FIG. 12 is a fragmentary perspective view of the embodiment being folded, a guard band being omitted.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

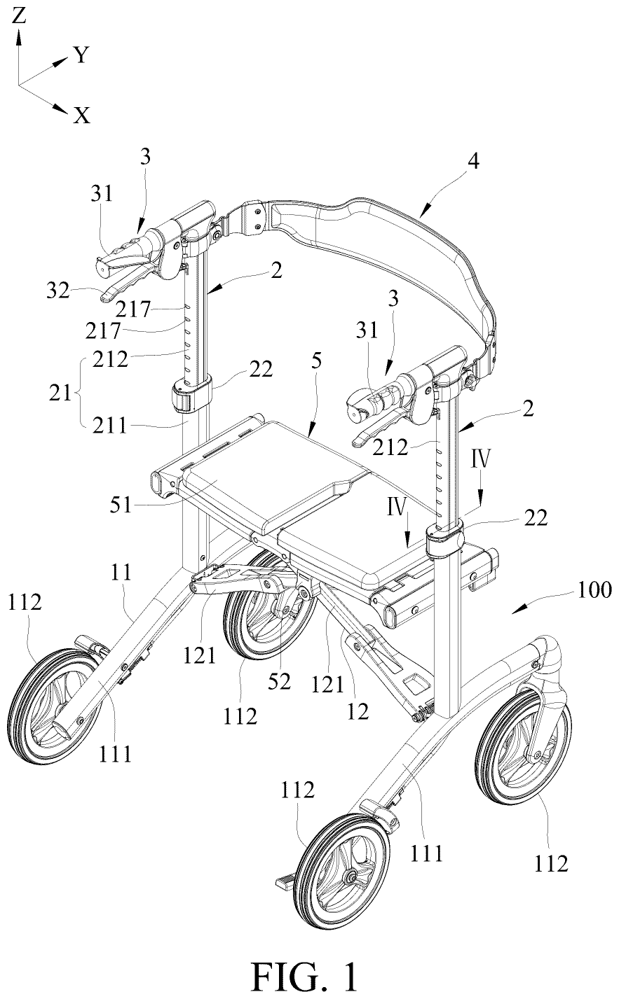

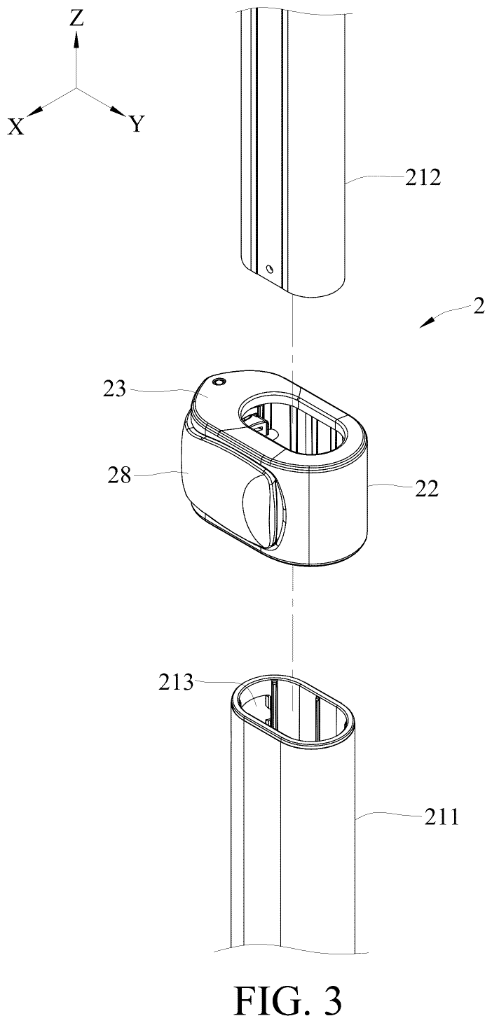

Referring to FIGS. 1 to 3, an embodiment of a rollator with adjustable handlebars according to the disclosure includes a frame unit 100, two handlebar units 3, a guard band 4, and an auxiliary unit 5. This embodiment can be used in different scenarios; specifically, it can assist users with mobility issues to walk on their own, or allow users to sit thereon and be pushed by caregivers (i.e., can serve as a transport chair).

The frame unit 100 includes a main body 11 which is movable, two adjustable bar devices 2 which extend in a first direction (Z), and which are respectively disposed on two opposite sides of the main body 11, and a linkage assembly 12 which pivotably interconnects the main body 11 and the auxiliary unit 5. The main body 11 includes two bottom bars 111 that are spaced apart from each other in a second direction (X) transverse to the first direction (Z), and multiple wheels 112 that are rotatably mounted to the bottom bars 111. In use, the main body 11 can be moved on the ground through rotation of the wheels 112. In this embodiment, the main body 11 includes four wheels 112 that are respectively mounted to front and rear ends of the bottom bars 111. The front and rear ends of the bottom bars 111 are spaced apart from each other in a third direction (Y) transverse to the first direction (Z) and the second direction (X). In this embodiment, the first direction (Z) is the top-bottom direction, the second direction (X) is the left-right direction, and the third direction (Y) is the front-rear direction, but the disclosure is not limited to such.

Specifically, the adjustable bar devices 2 are respectively disposed on the bottom bars 111 of the main body 11. For the sake of brevity, since the adjustable bar devices 2 are the same, only one of the adjustable bar devices 2 will be illustrated in the followings.

The adjustable bar device 2 includes an extendable bar assembly 21 that extends from the respective bottom bar 111 in the first direction (Z), and an adjustment unit 22 that is mounted to the extendable bar assembly 21 for adjusting extension and retraction of the extendable bar assembly 21 (i.e., adjusting a length of the extendable bar assembly 21).

The extendable bar assembly 21 includes an outer tube 211 and an inner tube 212 that is extendable and retractable relative to the outer tube 211 in the first direction (Z). In other words, the inner tube 212 slidably extends in the outer tube 211.

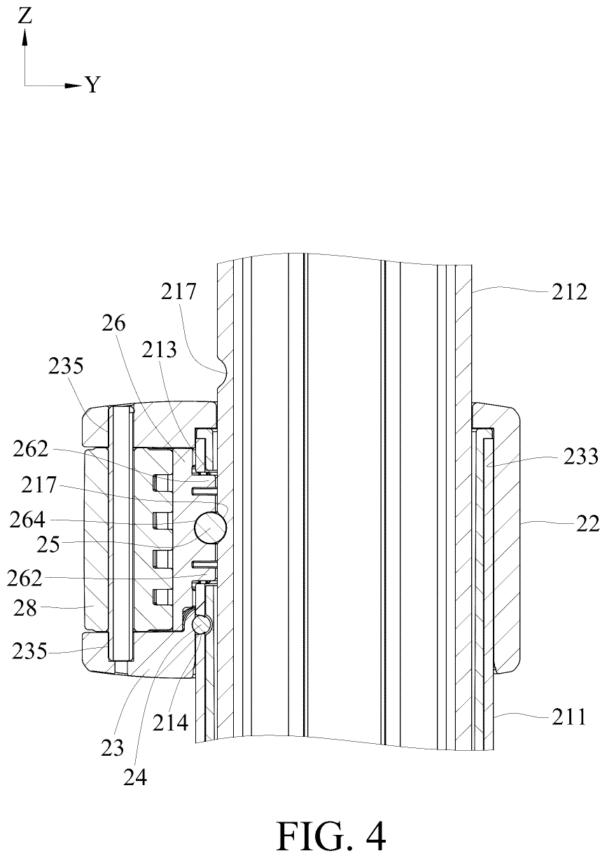

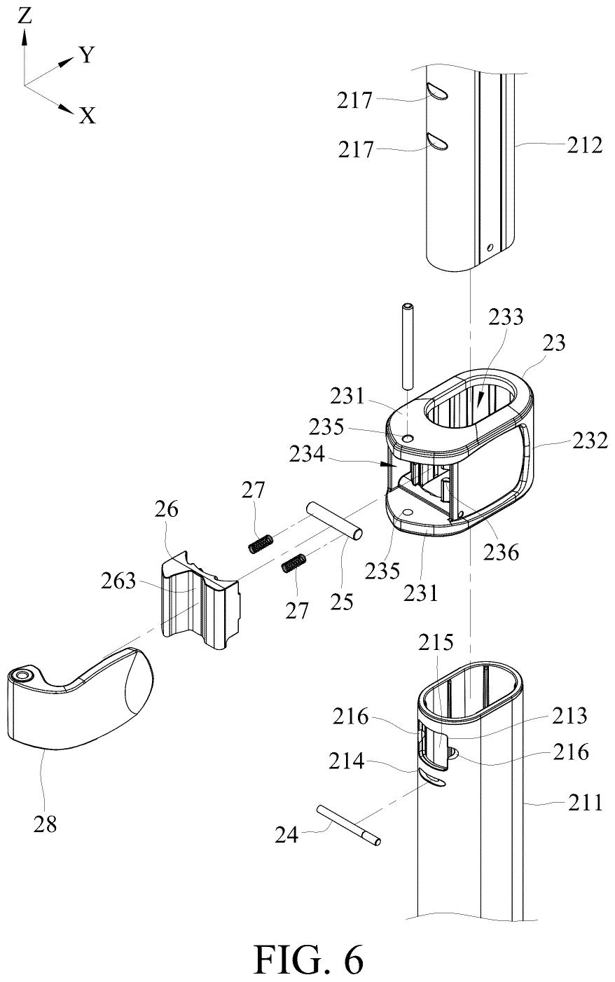

Referring to FIGS. 4 to 7, the outer tube 211 has an open groove 213 that extends through inner and outer surrounding surfaces of the outer tube 211, and a position groove 214 that is formed in the outer tube 211 and that is located under the open groove 213 in the first direction (Z). The open groove 213 has a main portion 215 that is substantially in a rectangular shape, and two side portions 216 which respectively extend from two opposite sides of the main portion 215, which are spaced apart from each other in the second direction (X), and each of which has a semi-circular shape. The position groove 214 extends in the second direction (X). The inner tube 212 has a plurality of recess portions 217 that are spaced apart from each other in the first direction (Z) and that are formed in an outer surface thereof. Specifically, each of the recess portions 217 may extend through the outer surface of the inner tube 212, but not through an inner surface of the inner tube 212; that is, each of the recess portions 217 is spaced apart from the inner surface of the inner tube 212.

In this embodiment, the inner tube 212 can be slid in a top portion of the outer tube 211 along the first direction (Z), so as to adjust the length of the extendable bar assembly 21. In other embodiments, positions of the inner tube 212 and the the outer tube 211 along the first direction (Z) may be interchanged (i.e., the outer tube 211 is located above the inner tube 212), so that the outer tube 211 is extendable and retractable relative to the inner tube 212 to adjust the length of the extendable bar assembly 21, but the disclosure is not limited to such.

The adjustment unit 22 includes a secure seat 23, a secure rod 24, a push rod 25, a push block 26, at least one resilient member 27, and an operation member 28. In this embodiment, the adjustment unit 22 includes two resilient members 27, but is not limited thereto.

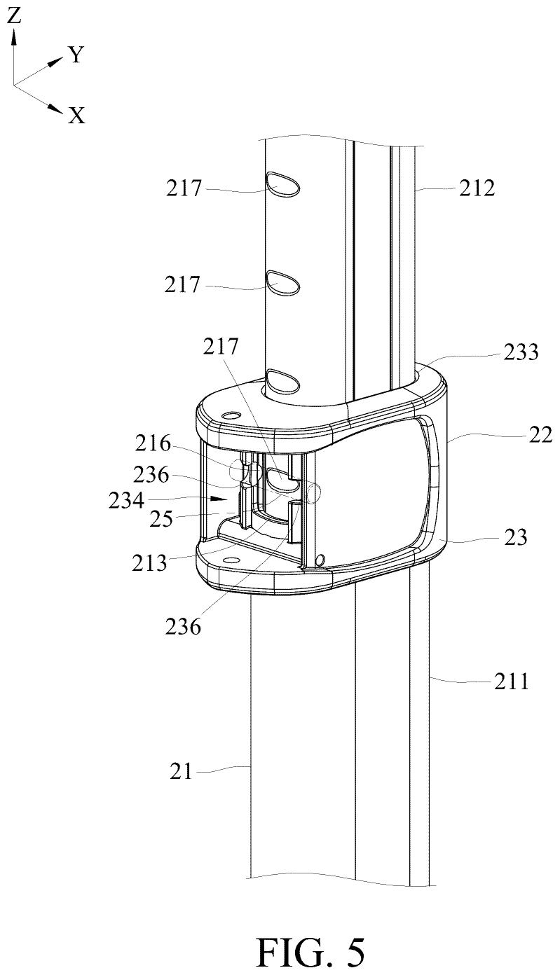

The secure seat 23 is firmly sleeved on the top end of the outer tube 211, and the inner tube 212 slidably extends in the secure seat 23. The secure seat 23 has two base walls 231 that are spaced apart from each other in the first direction (Z), and a surround wall 232 that is connected between the base walls 231, and the base walls 231 and the surround wall 232 cooperatively define an opening 233 and a recess space 234. Specifically, the top end of the outer tube 211 extends through the opening 233, and the inner tube 212 slidably extends in the outer tube 211, so that the inner tube 212 is slidable in the secure seat 23. The opening 233 spatially communicates with the open groove 213. The recess space 234 spatially communicates with the opening 233, and overlaps and spatially communicates with the open groove 213 of the outer tube 211 (specifically, a center of the main portion 215 is substantially aligned with a center of the recess space 234 in the third direction (Y)). Each of the base walls 231 has an axle hole 235 that extends in the first direction (Z). The surround wall 232 has two engagement grooves 236 that are located at a junction of the opening 233 and the recess space 234 (see FIG. 5), and that receive the push rod 25. The engagement grooves 236 respectively correspond in position to the side portions 216 of the open groove 213 of the outer tube 211, and each of the engagement grooves 236 spatially communicates with the respective side portion 216.

The secure rod 24 extends in the second direction (X), is mounted to the secure seat 23, and is partially exposed from the opening 233. In this embodiment, the exposed portion of the secure rod 24 engages the position groove 214 of the outer tube 211, so that the secure seat 23 is firmly sleeved on the top end of the outer tube 211. In other embodiments, the secure seat 23 may be firmly sleeved on the outer tube 211 by screws, rivets, snap-fitting, etc., but is not limited hereto.

Referring to FIGS. 5, 6 and 8, the push rod 25 extends in the second direction (X), and is accommodated in the recess space 234 of the secure seat 23 and the open groove 213 of the outer tube 211. In this embodiment, the push rod 25 is received in the engagement grooves 236 of the secure seat 23 and the side portions 216 of the open groove 213 of the outer tube 211. A length (L) of the push rod 25 in the second direction (X) is greater than (specifically, is several times) a width (W) of the push rod 25 in the third direction (Y). In this embodiment, the push rod 25 is a long cylindrical rod; thus, the width (W) of the push rod 25 is the diameter of the push rod 25. The push rod 25 is pressed in the third direction (Y) to engage one of the recess portions 217 of the inner tube 212, so as to limit a position of the inner tube 212. That is, compared to the prior art, the adjustment bar device 2 is positioned through the engagement between the push rod 25 and the recess portion 217, which has a greater engagement area, thereby having a stable engagement effect.

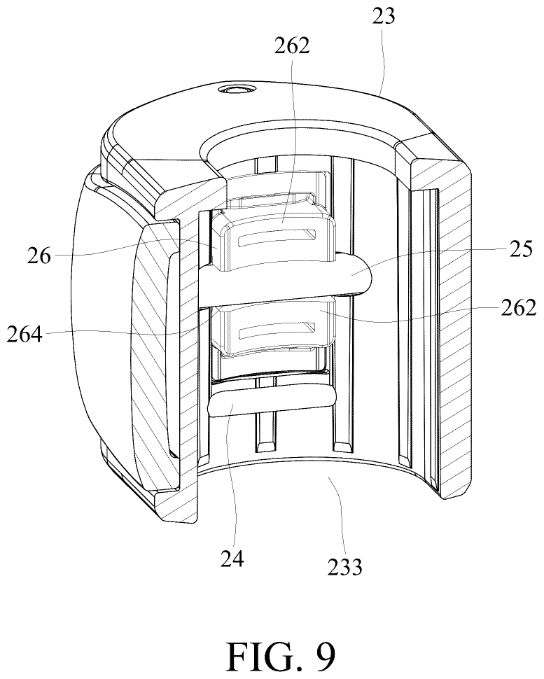

Referring to FIGS. 4 and 7 to 9, the push block 26 is movable in the third direction (Y), and is disposed on the secure seat 23. The push block 26 has two accommodation holes 261 that are spaced apart from each other in the second direction (X) and that respectively accommodate the resilient members 27, two protrusions 262 that are spaced apart from each other in the first direction (Z), and a concave portion 263 that is opposite to the protrusions 262 in the third direction (Y). The accommodation holes 261 are recessed opposite the extendable bar assembly 21. The push block 26 further has a receiving groove 264 that is defined by and located between the protrusions 262, that extends in the second direction (X), and that receives the push rod 25. The concave portion 263 is opposite to the receiving groove 264. The push rod 25 is located between the protrusions 262.

Moreover, since the push rod 25 is limited by the protrusions 262 in the first direction (Z), and is limited by the engagement grooves 236 of the secure seat 23 and the side portions 216 of the outer tube 211 in the second direction (X), the push rod 25 is stable and less likely to deviate.

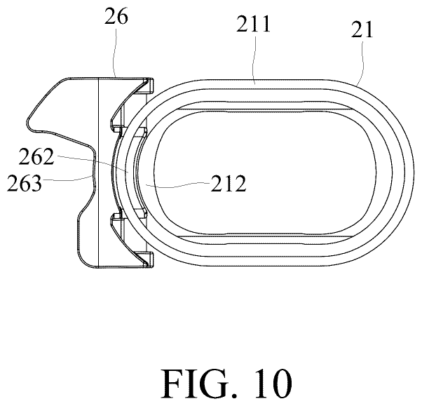

Referring to FIGS. 4 and 10, each of the protrusions 262 extends into the open groove 213 of the outer tube 211 and faces an outer surface of the inner tube 212. A contour of a surface of each of the protrusions 262 matches a contour of the outer surface of the inner tube 212. For example, in this embodiment, the surface of each of the protrusions 262 is concave, and the outer surface of the inner tube 212 is convex, but the disclosure is not limited thereto.

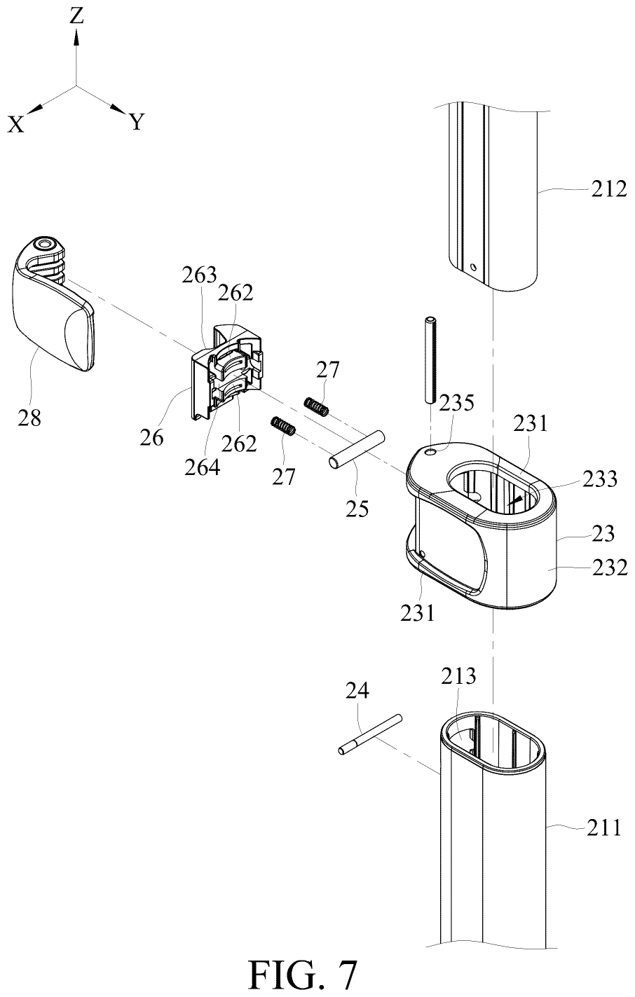

Referring to FIGS. 7, 8 and 11, the resilient members 27 are resiliently pressed in the third direction (Y), are disposed between the push rod 25 and the push block 26, and are able to resiliently bias the push rod 25 to move toward the inner tube 212 for engaging one of the recess portions 217. In this embodiment, each of the resilient members 27 is a compression spring, and for each of the resilient members 27, an end of the resilient member 27 is accommodated in the respective accommodation hole 261, and another end of the resilient member 27 abuts against the push rod 25.

The operation member 28 is movably disposed on the secure seat 23, and is operable for urging the push block 26 to move in the third direction (Y). In this embodiment, the operation member 28 has a cam portion 281 that is pivotably connected to the axle holes 235 of the secure seat 23 and that is operable for pushing the concave portion 263, and an operation portion 282 that extends outward from the cam portion 281.

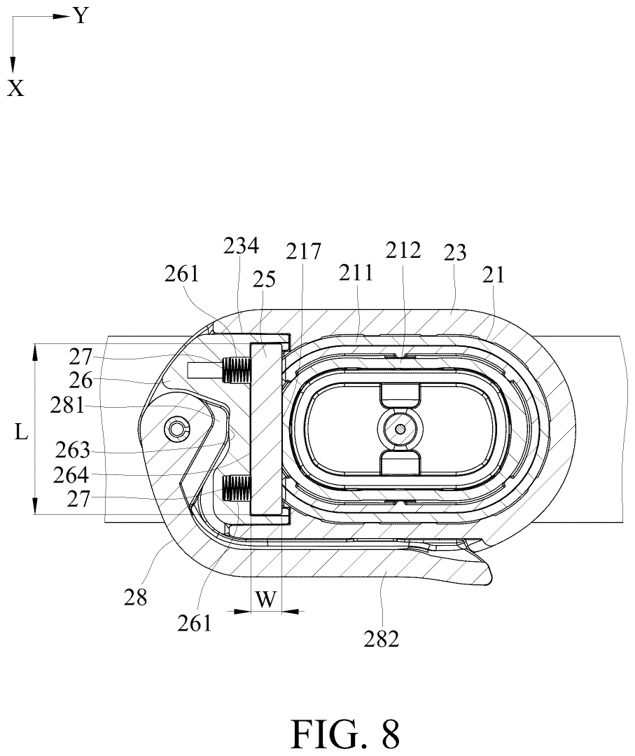

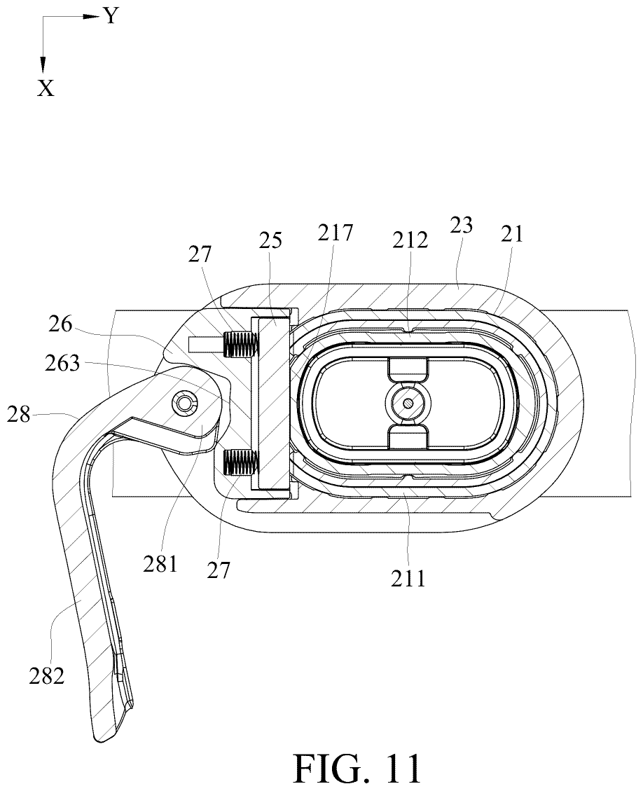

The operation member 28 can be pivoted between a limitation position (see FIG. 8) and a release position (see FIG. 11).

Referring to FIG. 8, when the operation member 28 is at the limitation position, the operation portion 282 is adjacent to the secure seat 23, and the cam portion 281 abuts against and pushes the concave portion 263 of the push block 26. The push block 26 abuts against the push rod 25 and is urged to press the resilient members 27, so that the resilient members 27 push the push rod 25, and thus the push rod 25 engages one of the recess portions 217 of the inner tube 212 to limit a position of the inner tube 212.

Referring to FIG. 11, when the operation member 28 is at the release position, the operation portion 282 is away from the secure seat 23, and the cam portion 281 is separated from the concave portion 263 of the push block 26, so that the push block 26 and the push rod 25 are spaced apart from each other in the third direction (Y). Specifically, when the operation member 28 is pivoted from the limitation position to the release position, the operation portion 282 is moved outward (i.e., away from the secure seat 23), the cam portion 281 is separated from the concave portion 263 of the push block 26, and the push block 26 is no longer pushed by the operation member 28, so that the resilient members 27 resiliently bias the push block 26 away from the push rod 25, and thus the push block 26 and the push rod 25 are spaced apart from each other in the third direction (Y). When the operation member 28 is pivoted to the release position, the push rod 25 is resiliently biased by the resilient members 27 to engage the one of the recess portions 217 of the inner tube 212. At this time, the inner tube 212 can be moved in the first direction (Z). When the inner tube 212 is moved in the first direction (Z), and when there is no recess portion 217 facing the push rod 25, the outer surface of the inner tube 212 pushes the push rod 25 and thus the resilient members 27 are compressed by the push rod 25. When one of the recess portions 217 faces the push rod 25, the resilient members 27 resiliently bias the push rod 25 to engage the one of the recess portions 217, producing “click” noise, thereby achieving the effect of adjusting extension and retraction of the extendable bar assembly 21.

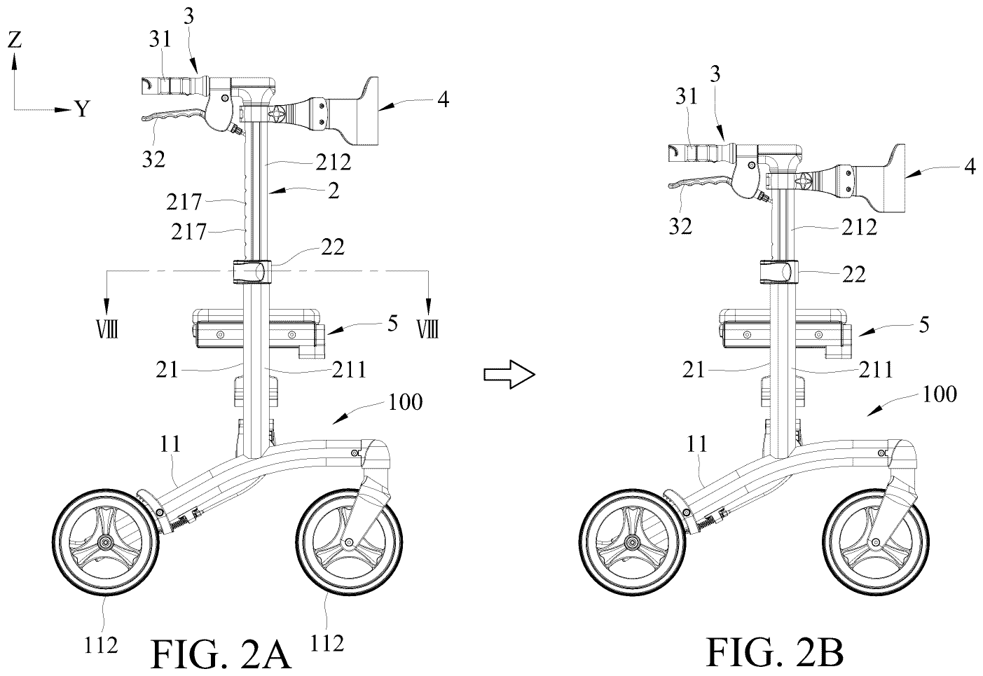

Referring to FIGS. 1 and 2A, B, the handlebar units 3 are respectively disposed on the adjustable bar devices 2 (specifically, top ends of the extendable bar assemblies 21 of the adjustable bar devices 2), and each handlebar unit 3 includes a handlebar member 31 that is mounted to the top end of the extendable bar assembly 21 (specifically, a top end of the inner tube 212) of the respective adjustable bar device 2, and a a brake 32 that is mounted to the top end of the extendable bar assembly 21 of the respective adjustable bar device 2, and that is operable for stopping the main body 11 from moving. Through adjusting extension and retraction of the extendable bar assemblies 21 (i.e., the length of the extendable bar assemblies 21), heights of the handlebar units 3 may also be adjusted, so as to serve users of different heights or body types, making the rollator with adjustable handlebars more ergonomic to use.

The guard band 4 is connected between the adjustable bar devices 2. The guard band 4 can be used as a backrest for a user when the rollator with adjustable handlebars serves as a wheelchair.

The auxiliary unit 5 is located between the handlebar units 3 and the main body 11 of the frame unit 100, and is connected between the adjustable bar devices 2. In this embodiment, the auxiliary unit 5 is a seat, and when this embodiment is used as a wheelchair, the user can sit on the auxiliary unit 5. The auxiliary unit 5 includes a seat pad 51 that is connected between the adjustable bar devices 2, and a pivot base 52 that is connected to the seat pad 51 and that is connected to the linkage assembly 12 of the frame unit 100. The seat pad 51 has two plates that are foldable. In this embodiment, the linkage assembly 12 is pivotably connected between the main body 11 and the seat pad 51 of the auxiliary unit 5.

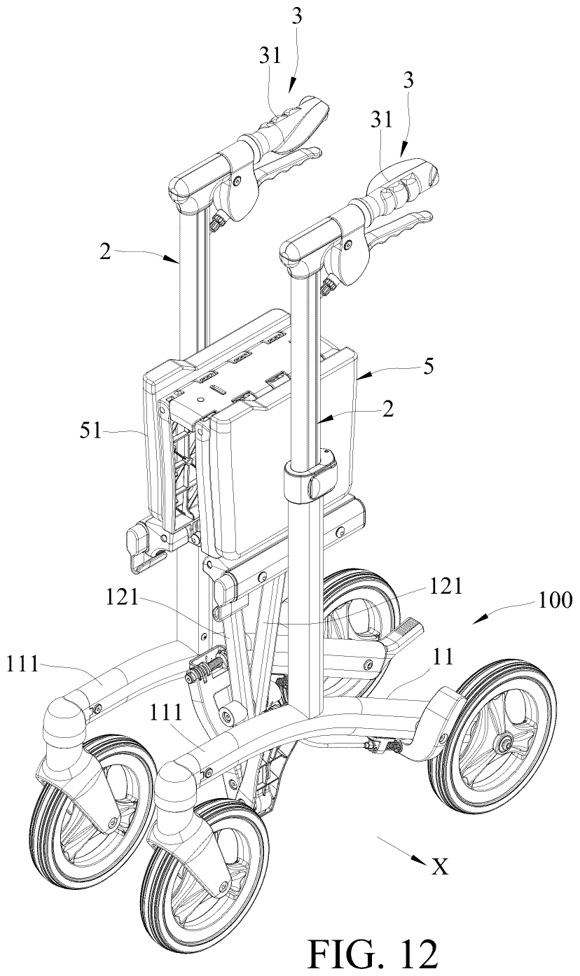

Referring to FIGS. 1 and 12, the linkage assembly 12 includes a plurality of connection bars 121 (two connection bars 121 in this embodiment) that are pivotably connected to each other, that cooperatively form an X shape, and that are operable for folding the rollator with adjustable handlebars in the second direction (X). When distal ends of the connection bars 121 are moved to be adjacent to each other in the second direction (X), the rollator is folded; when the distal ends of the connection bars 121 are moved to be away from each other in the second direction (X), the rollator is expanded for use. In other embodiments, the linkage assembly 12 may have different variations, which allows the rollator with adjustable handlebars to be folded in the first direction (Z) or the second direction (X). In some examples, the rollator with adjustable handlebars is not foldable.

In some examples, the auxiliary unit 5 may be a storage box, or a component with combination of a storage box and a seat; alternatively, the auxiliary unit 5 may also be omitted, but is not limited thereto.

It should be noted that, in addition to the rollator or transport chair, the adjustable bar devices 2 of the embodiment may also be used in wheelchairs, canes, walkers, and other similar auxiliary devices. In other words, the adjustable bar devices 2 of the disclosure cover various auxiliary devices such as those for people with mobility issues to walk on their own, those for people to sit thereon and to move by themselves, and those for people to sit thereon and to move by another person.

In summary, after the length of the extendable bar assemblies 21 has been adjusted, the operation member 28 is moved to the limitation position, the push block 26 is urged to press the resilient members 27 and abuts against the push rod 25, and thus the resilient members 27 push the push rod 25 in the third direction (Y), thereby the push rod 25 engaging one of the recess portions 217 of the inner tube 212 to limit a position of the inner tube 212. Since the adjustment bar devices 2 are positioned through the engagement between the push rods 25 and the recess portions 217, greater engagement areas are obtained, which leads to a stable engagement effect. Thus, the extendable bar assemblies 21 are not easily shaken, resulting in good stability during use, thereby achieving the object of the disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A rollator with adjustable handlebars, comprising:
a frame unit including a main body which is movable, and two adjustable bar devices which are respectively disposed on two opposite sides of said main body, and each of which includes
an extendable bar assembly including an outer tube, and an inner tube that is extendable and retractable relative to said outer tube in a first direction, said outer tube having an open groove, said inner tube having a plurality of recess portions that are spaced apart from each other in the first direction, and
an adjustment unit mounted to said extendable bar assembly for adjusting extension and retraction of said extendable bar assembly, and including a secure seat, a push rod, a push block, at least one resilient member and an operation member, said secure seat having an opening through which said outer tube extends so that said secure seat is sleeved on an end of said outer tube, and a recess space which spatially communicates with said opening and which overlaps said open groove of said outer tube, said push rod extending in a second direction transverse to the first direction, and being accommodated in said recess space of said secure seat and said open groove of said outer tube, a length of said push rod in the second direction being greater than a width of said push rod in a third direction transverse to the first direction and the second direction, said push rod being pressed to engage one of said plurality of recess portions of said inner tube, said push block being movable in the third direction, and being disposed on said secure seat, said at least one resilient member being resiliently pressed, being disposed between said push rod and said push block, and being able to resiliently bias said push rod to move toward said inner tube for engaging one of said plurality of recess portions of said inner tube, said operation member being movably disposed on said secure seat, and being operable for urging said push block to move in the third direction; and
two handlebar units respectively disposed on said adjustable bar devices, and each including a handlebar member that is mounted to said extendable bar assembly of said respective adjustable bar device.

2. The rollator with adjustable handlebars as claimed in claim 1, further comprising a guard band that is connected between said adjustable bar devices.

3. The rollator with adjustable handlebars as claimed in claim 1, further comprising an auxiliary unit that is located between said handlebar units and said main body of said frame unit, and that is connected between said adjustable bar devices.

4. The rollator with adjustable handlebars as claimed in claim 3, wherein said frame unit further includes a linkage assembly that interconnects said main body and said auxiliary unit, and that includes a plurality of connection bars, said plurality of connection bars being operable for folding said rollator with adjustable handlebars.

5. The rollator with adjustable handlebars as claimed in claim 4, wherein said plurality of connection bars are pivotably connected to each other and cooperatively form an X shape, said rollator being folded when distal ends of said plurality of connection bars are moved to be adjacent to each other in the second direction, said rollator being expanded when said distal ends of said plurality of connection bars are moved to be away from each other in the second direction.

6. The rollator with adjustable handlebars as claimed in claim 1, wherein:
said at least one resilient member includes two resilient members, said push block having two accommodation holes that are spaced apart from each other in the second direction and that respectively accommodate said resilient members; and
for each of said resilient members, an end of said resilient member is accommodated in said respective accommodation hole, and another end of said resilient member abuts against said push rod.

7. The rollator with adjustable handlebars as claimed in claim 1, wherein said push block has two protrusions that are spaced apart from each other in the first direction, each of said protrusions extending into said open groove of said outer tube and facing an outer surface of said inner tube, said push rod being located between said protrusions.

8. The rollator with adjustable handlebars as claimed in claim 1, wherein:
said push block has a receiving groove that receives said push rod, and a concave portion that is opposite to said receiving groove; and
said operation member has a cam portion that is pivotably connected to said secure seat and that is operable for pushing said concave portion, and an operation portion that extends outward from said cam portion.

9. The rollator with adjustable handlebars as claimed in claim 1, wherein:
said operation member is pivotable between a limitation position and a release position; and
when said operation member is at the limitation position, said operation portion is adjacent to said secure seat, and said cam portion abuts against and pushes said concave portion of said push block, so that said push block abuts against said push rod and is urged to press said at least one resilient member, and thus said at least one resilient member pushes said push rod, thereby said push rod engaging one of said plurality of recess portions of said inner tube.

10. The rollator with adjustable handlebars as claimed in claim 1, wherein:
said secure seat has two base walls that are spaced apart from each other in the first direction, and a surround wall that is connected between said base walls, said base walls and said surround wall cooperatively defining said opening and said recess space; and
said surround wall has two engagement grooves that are located at a junction of said opening and said recess space, and that receive said push rod.

11. The rollator with adjustable handlebars as claimed in claim 1, wherein said open groove of said outer tube has a main portion, and two side portions that respectively extend from two opposite sides of said main portion, a center of said main portion being substantially aligned with a center of said recess space of said secure seat in the third direction, said side portions being spaced apart from each other in the second direction, and receiving said push rod.

12. The rollator with adjustable handlebars as claimed in claim 1, wherein each of said handlebar units further includes a brake that is mounted to a top end of said extendable bar assembly of said respective adjustable bar device and that is operable for stopping said main body from moving.
